(19) United States
(12) Patent Application Publication
(10) Pub. No.: US 2019/0236514 A1
(43) Pub. Date: Aug. 1, 2019

(54) CONSECUTIVE USER TASKS TO DRIVE PROCESSES

(71) Applicant: SAP SE, Walldorf (DE)

(72) Inventor: Harald Schubert, Mannheim (DE)

(21) Appl. No.: 15/882,806

(22) Filed: Jan. 29, 2018

(51) Int. Cl. G06Q 10/06; G06F 17/30; G06F 3/0483; G06F 3/0484

(52) U.S. Cl. CPC G06Q 10/063114; G06F 3/0484; G06F 3/0483; G06F 17/30424

(57) ABSTRACT

A system for consecutive user tasks to drive processes is provided. In some implementations, the system performs operations comprising defining a plurality of workflow model tasks, the plurality of workflow model tasks comprising a first user task and a second user task. The operations further include assigning, in response to a selection in a first user interface, the second user task to be subsequent to the first user task; storing the assignment of the second user task in a database, the assignment comprising an identifier of the second user task; receiving an indication that the first user task was completed by a user; retrieving the identifier of the second user task from the database; and generating, in response to receiving the indication, a second user interface, the second user interface indicating to the user that the second user task is assigned to the user.

### TECHNICAL FIELD

The subject matter described herein relates generally to database processing and more specifically to the use of consecutive tasks in the management of data processing.

### BACKGROUND

Workflow management systems deal with the automation of processes involving human interaction via user tasks and automated steps such as service tasks, rules tasks, script tasks, etc. These tasks are typically interleaved arbitrarily as required to achieve a certain outcome and formalized in a workflow model. Within a running workflow, each user task involving user interaction (data entry, approvals, etc.) is typically brought to the relevant peoples' attention (aka potential owners), e.g., via mail, via an inbox, etc. It is then for one of them to claim the task and complete it. Improved systems, apparatuses, and methods for managing user tasks within a workflow model may be desirable.

### SUMMARY

In some aspects, a method, computer program product and system are provided. In an implementation, a consecutive user task system is provided. The system can include (or otherwise utilize) at least one processor and/or memory, which can be configured to perform operations including defining a plurality of workflow model tasks, the plurality of workflow model tasks comprising a first user task and a second user task. The operations further include assigning, in response to a selection in a first user interface, the second user task to be subsequent to the first user task. The operations further include storing the assignment of the second user task in a database, the assignment comprising an identifier of the second user task. The operations further include receiving an indication that the first user task was completed by a user. The operations further include retrieving the identifier of the second user task from the database. The operations further include generating, in response to receiving the indication, a second user interface, the second user interface indicating to the user that the second user task is assigned to the user.

In another aspect, there is provided a customized user consecutive task system. The system may include at least one data processor and at least one memory. The at least one memory may store instructions that result in operations when executed by the at least one data processor. The operations may include retrieving, by the at least one processor from a database, one or more tasks of a plurality of workflow model tasks assigned to a first user. The operations further include determining an order for completing the one or more tasks assigned to the first user. The operations further include displaying a first user interface, the first user interface comprising an indication of the one or more tasks assigned to the first user in the determined order. The operations further include receiving an indication of completion of a first task of the one or more tasks. The operations further include displaying, in response to receiving the indication, a second user interface, the second user interface based on the first user interface and the received indication.

In another aspect, a computer implemented method is provided. The method includes defining a plurality of workflow model tasks, the plurality of workflow model tasks comprising a first user task and a second user task. The method further includes assigning, in response to a selection in a first user interface, the second user task to be subsequent to the first user task. The method further includes storing the assignment of the second user task in a database, the assignment comprising an identifier of the second user task. The method further includes receiving an indication that the first user task was completed by a user. The method further includes retrieving the identifier of the second user task from the database. The method further includes generating, in response to receiving the indication, a second user interface, the second user interface indicating to the user that the second user task is assigned to the user.

In another aspect, a non-transitory computer program product is provided. The product can store instructions which, when executed by at least one data processor, causes operations comprising defining a plurality of workflow model tasks, the plurality of workflow model tasks comprising a first user task and a second user task. The operations further include assigning, in response to a selection in a first user interface, the second user task to be subsequent to the first user task. The operations further include storing the assignment of the second user task in a database, the assignment comprising an identifier of the second user task. The operations further include receiving an indication that the first user task was completed by a user. The operations further include retrieving the identifier of the second user task from the database. The operations further include generating, in response to receiving the indication, a second user interface, the second user interface indicating to the user that the second user task is assigned to the user.

In some variations, one or more features disclosed herein including the following features can optionally be included in any feasible combination. In some aspects, the operations can include querying, by the at least one processor, the database for an identifier of a subsequent task associated with the first user task; and receiving, from the database and in response to the querying, a response indicating the identifier of the second user task. In some implementations, the displaying is based on a number of querying attempts and/or a time period threshold. In some implementations, the operations further comprise storing, for each task of the plurality of workflow model tasks, a definition of a task in the database, the definition comprising a process for completing the task. Additionally, the second user interface can indicate the completion of the first user task and can comprises a button directing the user to the second user task.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram illustrating a workflow model, in accordance with some example implementations;

FIG. 2 depicts the workflow model of FIG. 1 comprising an indication of where a user is located within the workflow model, in accordance with some example implementations;

FIG. 3 depicts a workflow model and an associated user interface, in accordance with some example implementations;

FIG. 4 depicts a table illustrating a communication exchange between a client device and a workflow engine, in accordance with some example implementations;

FIG. 5 depicts an exemplary workflow model for a company car ordering process, in accordance with some example implementations;

FIG. 6 depicts an exemplary user interface, in accordance with some example implementations;

FIG. 7 depicts an exemplary user interface, in accordance with some example implementations;

FIG. 8 depicts a workflow model illustrating parallel processes, in accordance with some example implementations;

FIG. 9 depicts an exemplary user interface illustrating a custom view for a user of the workflow model of FIG. 8, in accordance with some example implementations;

FIG. 10 depicts an exemplary user interface, in accordance with some example implementations;

FIG. 11 depicts a workflow model including branches, in accordance with some example implementations;

FIG. 12 depicts an exemplary user interface, in accordance with some example implementations;

FIG. 13 depicts a workflow model including loops, in accordance with some example implementations;

FIG. 14 depicts an exemplary user interface, in accordance with some example implementations;

FIG. 15A depicts a flowchart illustrating a process for consecutive task modeling, in accordance with some example implementations;

FIG. 15B depicts a flowchart illustrating a process for generating a customized user interface, in accordance with some example implementations; and

FIG. 16 depicts a block diagram illustrating a computing system, in accordance with some example implementations.

When practical, similar reference numbers denote similar structures, features, or elements.

### DETAILED DESCRIPTION

To address these and potentially other deficiencies of currently available solutions, one or more implementations of the current subject matter relate to methods, systems, articles of manufacture, and the like that can, among other possible advantages, provide use of consecutive user task modeling and display.

A common problem found in a data management system arises when the same single user is involved in multiple user tasks that might or might not be consecutive but happen within a very short period of time (possibly a few seconds). In some aspects, when the time spent on the service tasks between these two user tasks is short, it can be desirable for the user to be guided through these two user steps in sequence.

Contemporary workflow management solutions fail to address this problem. Because of that, developers typically try to combine such consecutive user tasks into one task—from the standpoint of the workflow model. To this end, wizard-like user interfaces (UIs) are often used that guide users through the individual steps of the task. In some aspects, where service tasks or other background activities are needed, the wizard-like UIs turn into error-prone and tedious UI development activities that have the UIs themselves call out to those services. These steps can now be completely invisible to, and bypass, the workflow management system. This process can basically void the advantages of using a workflow management system in the first place (e.g., handling remote communication, error handling, compensation, support for asynchronicity, auditability, etc.).

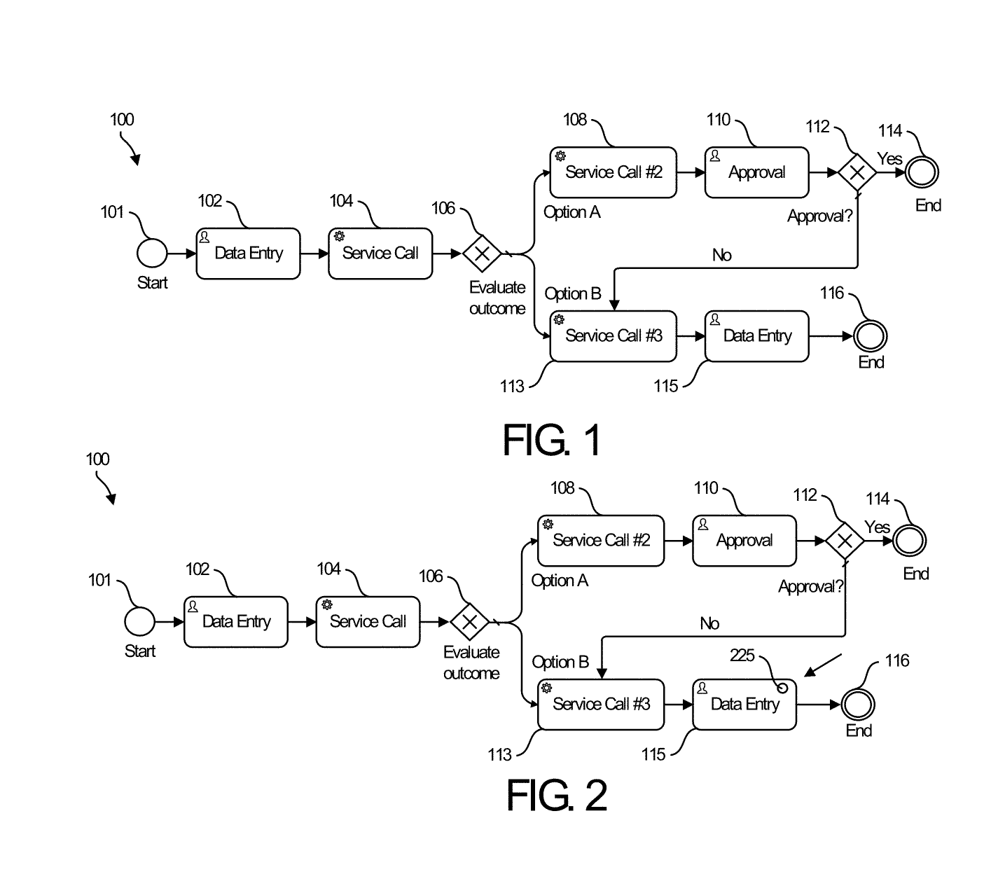

FIG. 1 depicts a diagram illustrating a workflow model 100, in accordance with some example implementations. As shown in FIG. 1, the workflow model 100 starts at block 101 and proceeds to the first user task 102 called “Data Entry.” After the user task 102 is completed, the workflow model 100 proceeds to service call 104. In some aspects, the service call 102 can comprise an automated step or process. At block 106, the workflow can evaluate the outcome of the Data Entry 102 and/or the service call 104. As shown in FIG. 1, the evaluation can proceed the workflow according to one of two options (e.g., Option A or Option B). In some implementations, more or fewer options are possible. If the workflow proceeds according to Option A, the workflow advances to service call 108 (Service Call #2). In some aspects, the service call 108 can comprise an automated step or process. After service call 108, the workflow proceeds to a second user task 110 called “Approval.” At block 112, the workflow checks whether the user approved of the data entry in the first user task 102. If yes, the workflow proceeds to block 114 and the workflow ends. If the user during the second user task 110 did not approve, then the workflow proceeds to service call 113 (Service Call #3). Additionally, if after the evaluation at block 106, the workflow proceeds according to Option B, the workflow would also continue to service call 113. In some aspects, the service call 113 can comprise an automated step or process. After service call 113, the workflow advances to a third user task 115 called “Data Entry.” In some aspects, the third user task 115 can be prompted to correct errors that occurred as a result of the first user task 102. After, the third user task 115 completes, the workflow continues to block 116 where the workflow ends.

In some example implementations, it is possible for the same person to work on the first user task 102 (Data Entry) as well as the second user task 110 (Approval). In some aspects, it may be desirable for this same user to be guided through these two steps in sequence (data entry followed by an approval), without the user having to complete the first user task 102, then refresh his inbox or wait for another e-mail to appear in his e-mail client, before seeing the second user task 110 and working on it.

Another issue in workflow management systems is that participants in a workflow are often interested in seeing their past and future involvement into a workflow beyond the task they are currently processing. Contemporary workflow management systems typically try to address this concern by presenting the workflow models directly to these users and indicating where in the flow the user is at present.

FIG. 2 depicts the workflow model 100 comprising an indication 225 indicating where a user is located within the workflow model 100, in accordance with some example embodiments. As shown in FIG. 2, workflow models (such as workflow model 100), can be complex and can typically involve a lot of activities that are not understood by (i.e. overwhelming), and/or not interesting for, the participants in a workflow. Simply presenting a 1:1 model to participants does not achieve the desired effect.

Alternatively, some workflow management systems allow capturing a second, presentation-level model that “overlays” the executed workflow model and represents a more simplified version of the original model (e.g., a value-chain like visualization). A drawback with this approach is that these two models can quickly go out of sync and that the overlay is often static in nature, making it hard to give a more precise view of what's lying ahead in a model (e.g., if there are alternative paths that can be taken as shown in the example above). The implementations disclosed herein, describe the notion of consecutive tasks which aims at addressing both problems.

In some aspects, in constructing workflow models, a developer identifies user tasks in a workflow that are supposed to be worked upon by a same single person. Such relationships can be explicitly declared between user tasks. The person assigned to work on the first user task in a group of consecutive tasks can also be assigned to be the person working on all remaining user tasks of that group. When modeling a user task within a workflow, the developer can be presented with an option to select an upstream user task in the workflow and mark the current user task as subsequent to a previous user task.

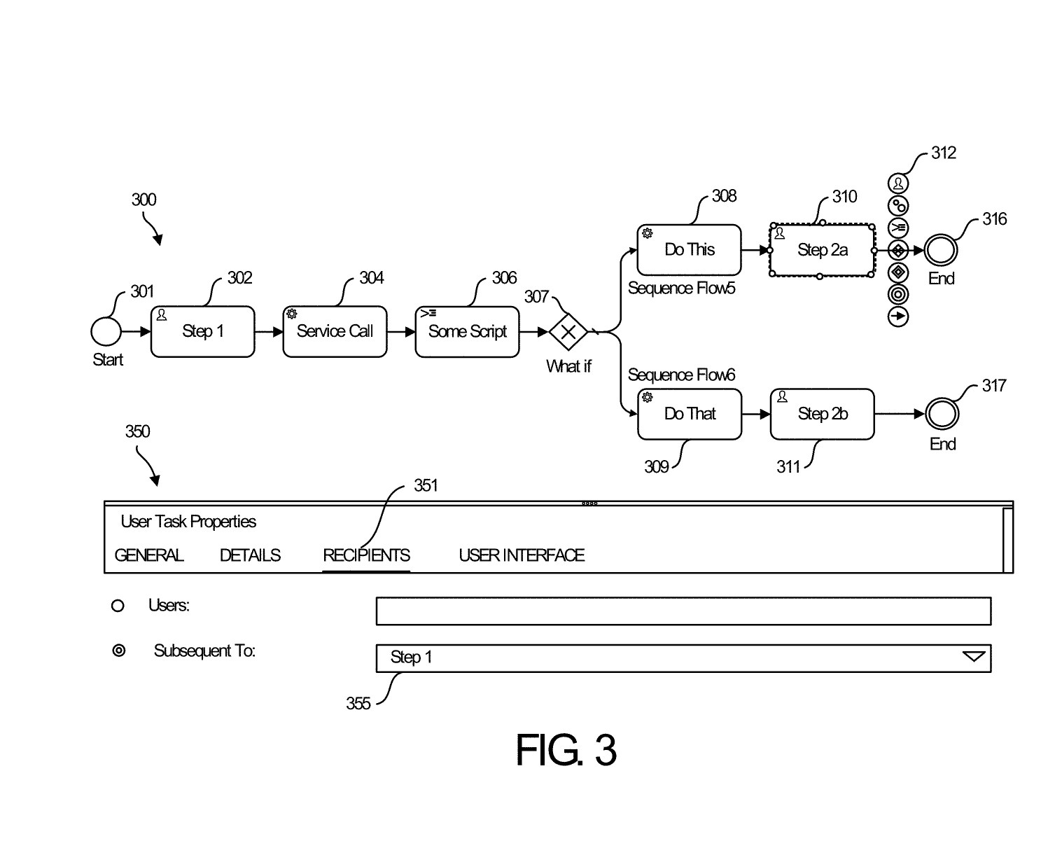

FIG. 3 depicts a workflow model 300 and an associated user interface 350, in accordance with some example embodiments. The workflow model 300 comprises, start 301, user task 302 (labeled “Step 1”), service call 304, script 306, “What if” decision block 307, “Do This” task 308, “Do That” task 309, user task 310 (labeled “Step 2a”), user task 311 (labeled “Step 2b”), tools menu 312, end process 316, and end process 317.

As shown in FIG. 3, the block 310 (user task Step 2a) is highlighted/selected and the user interface 350 can be displayed in response to the selection. The user interface 350 comprises a “Recipients” tab configured to allow a developer to select which users to assign to the task 310. Additionally, the developer can select which step in the workflow model the current step (Step 2a) will be subsequent to. As shown in field 355 of FIG. 3, the user task 310, Step 2a, is selected to be subsequent to Step 1 (user task 302). As a result of such an assignment, if a user successfully completes user task 302 (Step 1), he/she will also be in charge of completing user task 310, (Step 2a) if that step is ever reached. If the other branch is taken, user task 311 (Step 2b) can be executed instead.

In some implementations, the user task 311 (Step 2b) may not be configured as consecutive to Step 1. In such an example, the user completing user task 302 can be instructed at runtime to wait for the next task (user task 310, (Step 2a)), but such no such task would ever follow given the workflow model. In some aspects, a processor or workflow engine can perform a static analysis of the workflow model which can detect such potential errors/inconsistencies upfront and guide the developer accordingly. From a runtime perspective, a consecutive task (e.g., user task 310) assigned to a user as shown in user interface 350 is implicitly not available to any user but the user who completed the first task (e.g., user task 302).

In order to prevent such potential errors/inconsistencies, in some aspects, the workflow engine could inform the client device (e.g., inbox) that an initially subsequent task is now obsolete (in the above example the workflow engine could do this after the decision gateway has been executed). In some implementations, the determination that a subsequent task is obsolete is based on sufficient data being available for the workflow engine to take a decision. The client device could then react accordingly, e.g., by no longer waiting for the next subsequent task, selecting the next task in an overall task list, and/or the like.

In some implementations, a workflow model (e.g., workflow model 300) can be implemented by a workflow engine in communication with a client device. In some aspects, the workflow engine can comprise a server or other computing device. In some implementations, the workflow engine and/or the client device comprise a processor, a memory, a transceiver, and/or an input/output component. In some aspects, a user can complete tasks of the workflow on the client device and the workflow engine can communicate user tasks to the client device and/or execute service tasks and/or automatic system tasks. In other aspects, the client device can execute the service tasks and/or automatic system tasks.

For a user executing one or more user tasks of a workflow model, once the user finishes a first task (e.g., user task 302) in a group of assigned tasks, he/she can automatically be presented the next task (e.g., user task 310), given that the workflow engine can advance in the execution of the embedding workflow instance in a timely fashion. In some implementations, to ensure a timely execution of the embedding workflow instance, the workflow engine can be configured to synchronously execute steps following the first task up to the next consecutive task. This can prevent delays from automated workflow instances (e.g., service tasks) which are typically executed asynchronously. Otherwise, a busy indicator can presented to the user with the option to proceed with other work and be notified once the next user task in this group arrives.

When the user completes a task, the workflow engine can, based on the fact that a subsequent task was defined downstream in the model, notify the client device (e.g., an inbox) that another task will follow that logically belongs to the one just completed. In the example of FIG. 3, a user who completes user task 302 can be notified that he/she is also assigned the user task 310 (Step 2a) which should follow the user task 302. In some aspects, the client device of the user could then continuously fire a query to the workflow engine to obtain just that next task. In case no results are available as yet, an exponential backoff can be applied to not overwhelm the workflow engine. With no loss of generality, the following paragraphs illustrate a pull-based model based on an HTTP-like protocol. Push- or pull-based models atop HTTP or other protocols are equally applicable.

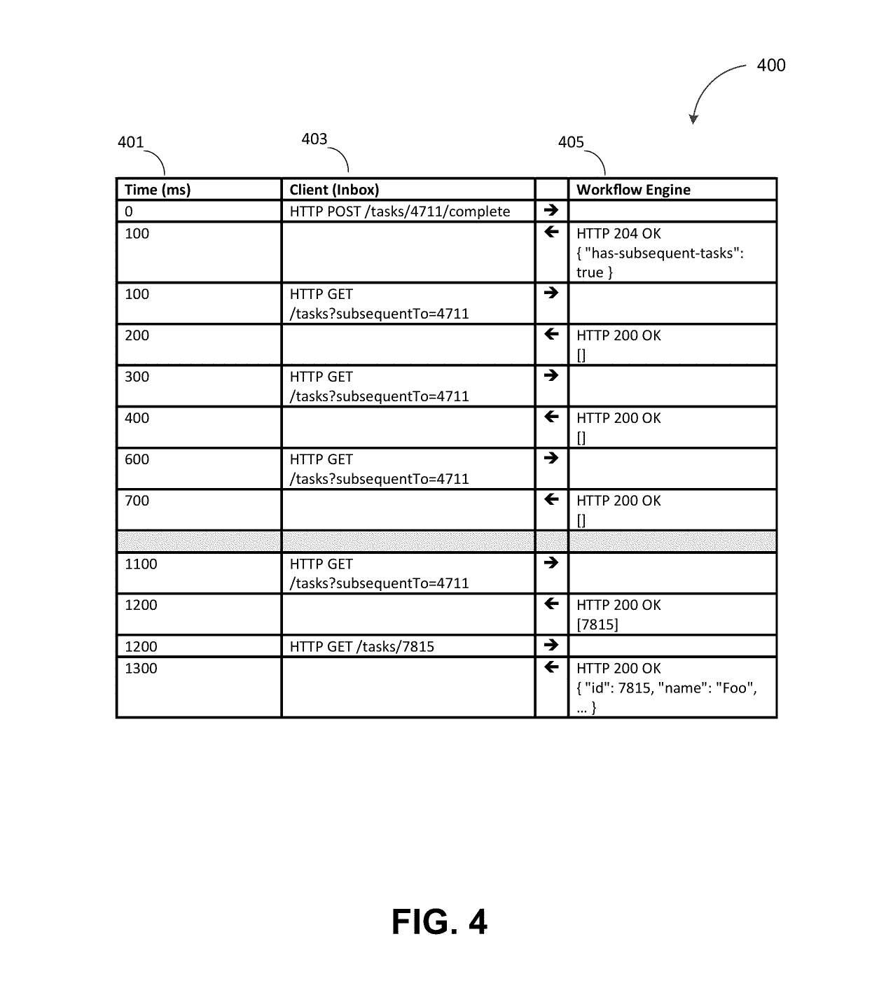

FIG. 4 depicts a table 400 illustrating a communication exchange between a client device and a workflow engine, in accordance with some example implementations. The table 400 comprises a column 401 illustrating a time of the communication exchange, a column 403 illustrating a client communication, and a column 405 illustrating a workflow engine communication.

The example of FIG. 4 shows how a client device inbox completes a task with ID 4711 at time 0 ms and then obtains the information that this task has subsequent tasks. The client inbox then queries (e.g., HTTP GET/tasks?subsequentTo=4711) the workflow engine for tasks subsequent to task 4711. As shown in FIG. 4, initially, the workflow engine has no tasks that match that criteria, hence it returns an empty list (e.g., “H”). The client inbox then starts to back off (waiting more and more time before it asks the workflow engine again). Finally, after the third attempt, the subsequent task is returned (e.g., “[7815]” at time 1200) and the client inbox can serve it to the user.

After the second attempt, as 600 milliseconds have passed since the client inbox asked for subsequent tasks for the first time (illustrated by the gray bar), the inbox client can render a busy indicator to the user. For example, the indicator may display a text to the user, e.g., “Please wait while we fetch subsequent tasks . . . ” or another message to indicate that the client is searching for subsequent tasks. The indicator may comprise icons, sounds, graphical displays or other indications to indicate that the client inbox is searching for tasks. In some aspects, the client inbox can display the indicator after a certain number and/or a certain time period has passed since a query has been sent to the workflow engine. In some implementations, the indicator can include a “Dismiss” button or other selection to close the indicator box. At this point, the user could opt out by pressing the “Dismiss” button at which point the client inbox would revert to default behavior and select the next task in an overall task list, for example.

In some implementations, a user may work on other things, leaving the busy dialog in place, but essentially directing his/her attention to other things, the client inbox can then display a notification once the subsequent task was delivered by the workflow engine. For example, the notification can display “Task Too' is ready to be worked upon” or some other indication at or after time 1300 ms when the workflow engine communicates the task ID and/or name to the client inbox. The notification may also comprise an “Open” and/or a “Dismiss” button, or another button. The Open button can be configured to take the user back to the client inbox and open task 7815. While “Open” and “Dismiss” buttons are described above, more or fewer buttons are possible consistent with the implementations described herein.

In some implementations, a user can access a personalized view of workflow instances he/she is involved in. This view, also referred to as “My Processes,” can present on a user interface past, current, and/or upcoming user tasks the user will be involved in based on consecutive tasks he/she already processed. If certain user tasks are not guaranteed to be triggered downstream in the workflow based on the course the workflow instance at hand takes, My Processes can display them with a certain level of uncertainty or not at all.

The My Processes view takes advantage of the information about consecutive tasks captured in the workflow model and presents the user with a list of workflow instances that require the user's attention (implying there are one or more user tasks the user is assigned to). The My Processes user interface view also gives the user an outlook of tasks that will become relevant later on during the workflow model process.

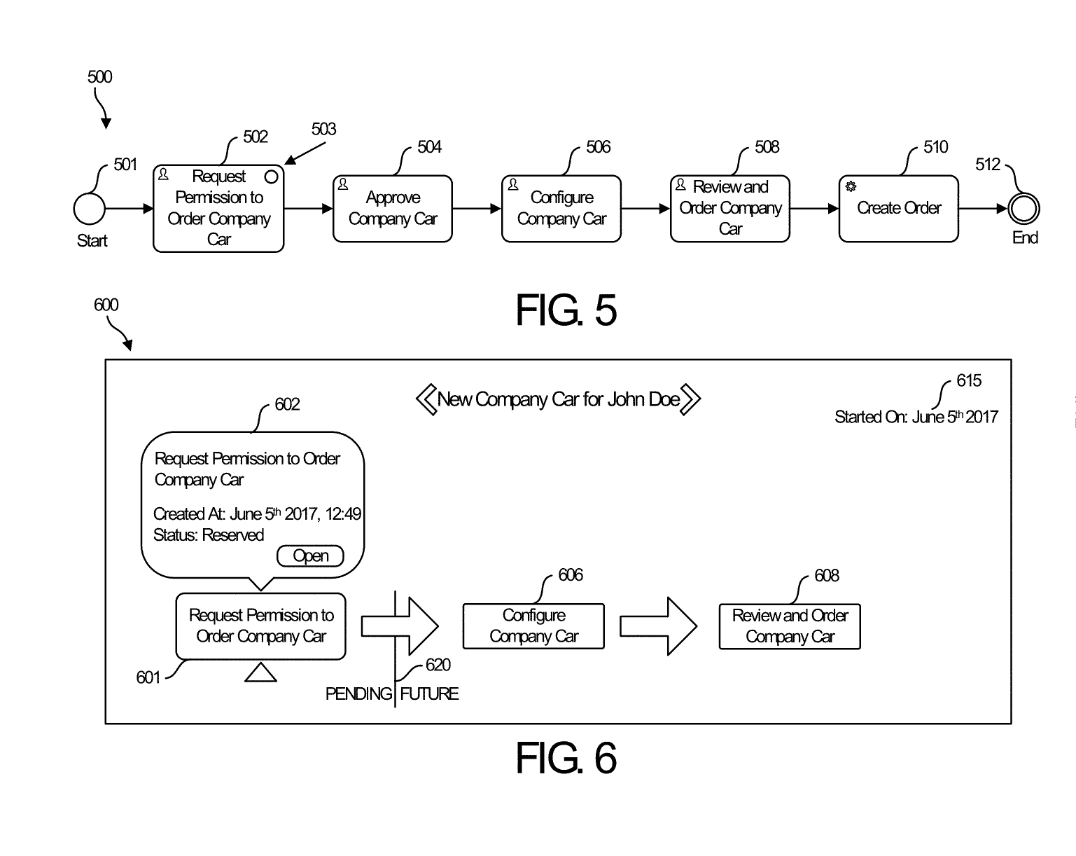

FIG. 5 depicts an exemplary workflow model 500 for a company car ordering process, in accordance with some example implementations. As shown in FIG. 5, at 501 the process starts and at 502, a user (e.g., employee) can request permission to order the company car. In some aspects, prior to the user task at 502, the employee can trigger a new instance of a company car ordering process (not visualized). The first user task at 502, is about requesting the permission from the employee's manager and providing, for example, some free text with a business reason. Next, at 504, the manager can approve the company car. Now, at 506, after receiving approval, the employee would be able to actually configure the car. In a subsequent task at 508, the user can review and order the car. After that, the order would be created in the backend system at 510. The process would then end at 512.

The example of FIG. 5 highlights several things: the employee would be involved in three consecutive tasks (but with the added complexity of a user task being assigned to somebody else—as discussed further below). In some aspects, the technical order creation at 510 is most likely not applicable for the employee. In the example of FIG. 5, the employee's manager would have to approve the request 502. Whether and when the manager approved the company car at 504 will be, generally speaking, of interest to the employee.

Based on the workflow model 500 and the first two observations above, the employee could see a customized user interface displaying one or more processes associated with the employee. In some aspects, the processes displayed comprise processes completed or to be completed by the employee. In some implementations, the user interface can be labeled “My Processes” and indicate which processes are the responsibility of the user/employee.

FIG. 6 depicts an exemplary user interface 600, in accordance with some example implementations. As shown in FIG. 6, the user interface 600 (e.g., a My Processes view) shows for ordering a new company car for the employee John Doe, there is one task which needs to be completed for the process (e.g., user task at 502) to proceed. As further shown, the left-hand side of the user interface 600 is labeled “Pending” for pending tasks with the right-hand side labeled “Future” for future tasks. In some aspects, a vertical line 620 may separate the Pending and Future tasks on the user interface 600. Furthermore, the employee can see at 601 the task that needs to be completed now (Pending). In some aspects, the user can select the block 601 and a window or message 602 can be displayed to the user. The window 602 can include further information regarding the pending task 601. As shown, in FIG. 6, the window 602 can include a timestamp for when the task was created, a current status of the task, and a button to open the task on a client device of the user.

While the example, of FIG. 6 illustrates the above information, other information and displays are possible. For example, the window 602 can also include a due date for completing the task, a dismiss or close button, a more information button, and/or any other information relevant to the user for completing the task. Additionally, on the right-hand side of the user interface 600, the user can see what tasks he will have to work on in the future (e.g., tasks 606 and 608 corresponding to user tasks 506 and 508 of FIG. 5). The user can interact with pending tasks and take action right from within the user interface 600 view (e.g., a My Processes view). The user interface 600 can also comprise a timestamp 615 indicating when a certain task was started by the user. Note, the service task creating the order in the backend (at 510 of FIG. 5) is not shown as it is not of interest to the user and is not completed by the user.

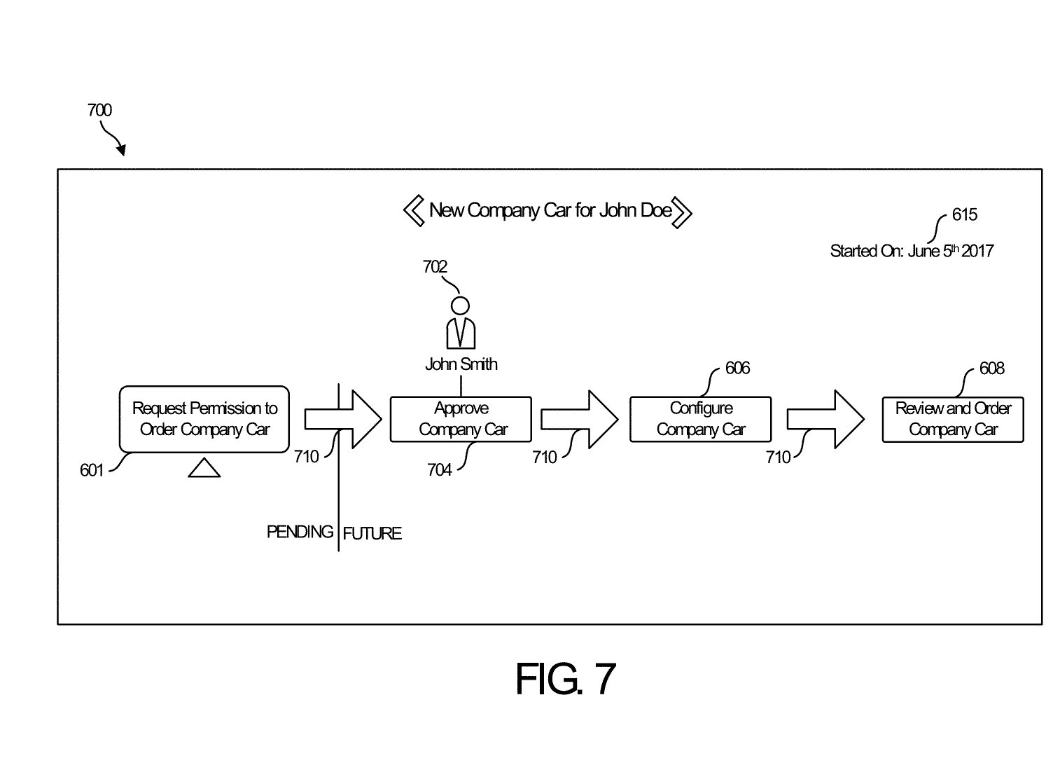

The user interface 600 is an example of a personalized view (e.g., a My Processes view) for the employee of the workflow model 500. Other users (for example the manager) can see a different user interface for the processes the manager is responsible for. If the personalized view (e.g., a My Processes view) now extends to also consider work done by other people that is important to the employee, e.g., the manager approving the company car ordering request, the My Processes view may customized for the manager as shown in FIG. 7 below (assuming John Smith is John Doe's manager).

FIG. 7 depicts an exemplary user interface 700, in accordance with some example implementations. As shown in FIG. 7, task 704 has been added to the user interface 600 of FIG. 6. User interface 700 also shows an indicator 702 indicating that the employee's manager, John Smith, is responsible for completing the task 704 of approving the request for the company car (user task 601). User interface 700 also may comprise arrow 710 to indicate an order of the processes in the workflow model for the user and/or other users to complete.

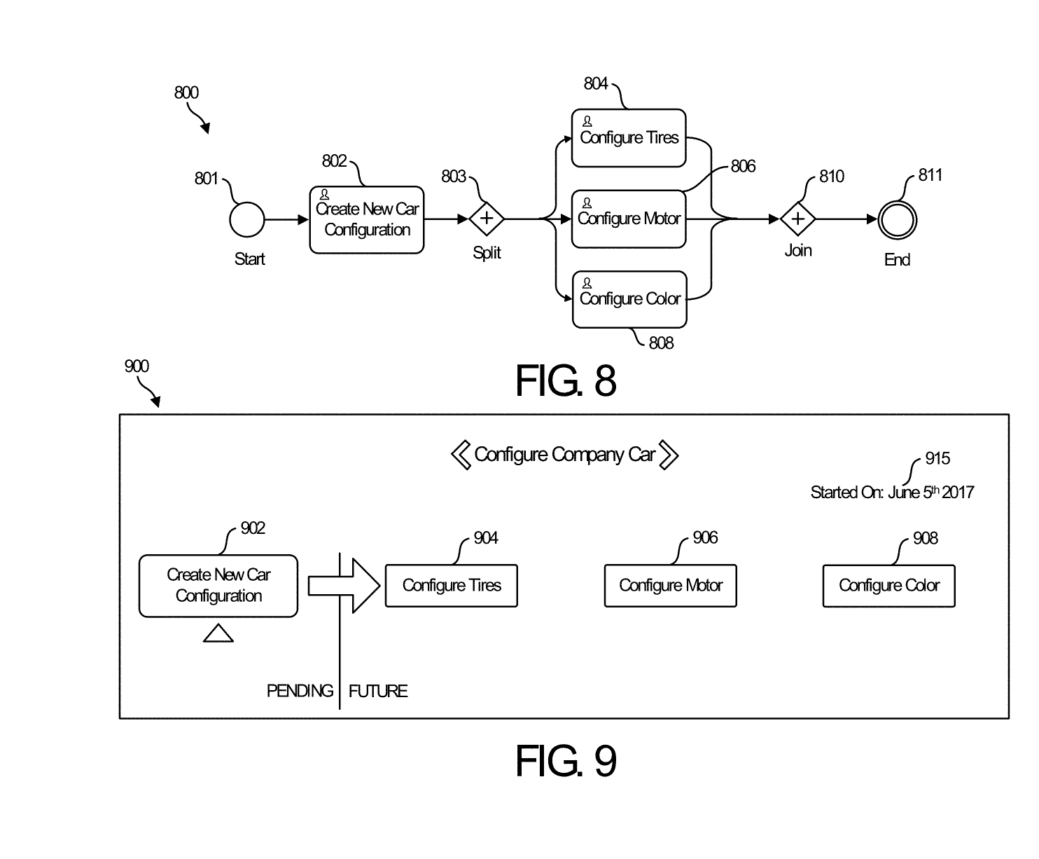

Workflows often also orchestrate work that happens in parallel. In general, there is technically nothing that keeps a user from being asked to do two things at a time. FIG. 8 depicts a workflow model 800 illustrating parallel processes, in accordance with some example implementations. Workflow model 800 comprises a start 801, a user task 802 (Configure New Car Configuration), a split 803 event, user task 804, user task 806, user task 808, join event 810, and an end of the process at 811. As shown in FIG. 8, the user task 804 (Configure Tires), user task 806 (Configure Motor), and user task 808 (Configure Color), are processes that can be completed in parallel by the user. In some implementations, these parallel user tasks, as long as not active, could simply show up under future in My Processes, but without arrows (e.g., arrows 710) between them to indicate that they are parallel tasks and/or that they do not need to be completed in sequence.

FIG. 9 depicts an exemplary user interface 900 illustrating a My Process view for a user of the workflow model 800, in accordance with some example implementations. As shown in FIG. 9, the future tasks 904, 906, and 908 do not have arrows in between them to indicate that they are not performed in sequence and/or can be completed in parallel.

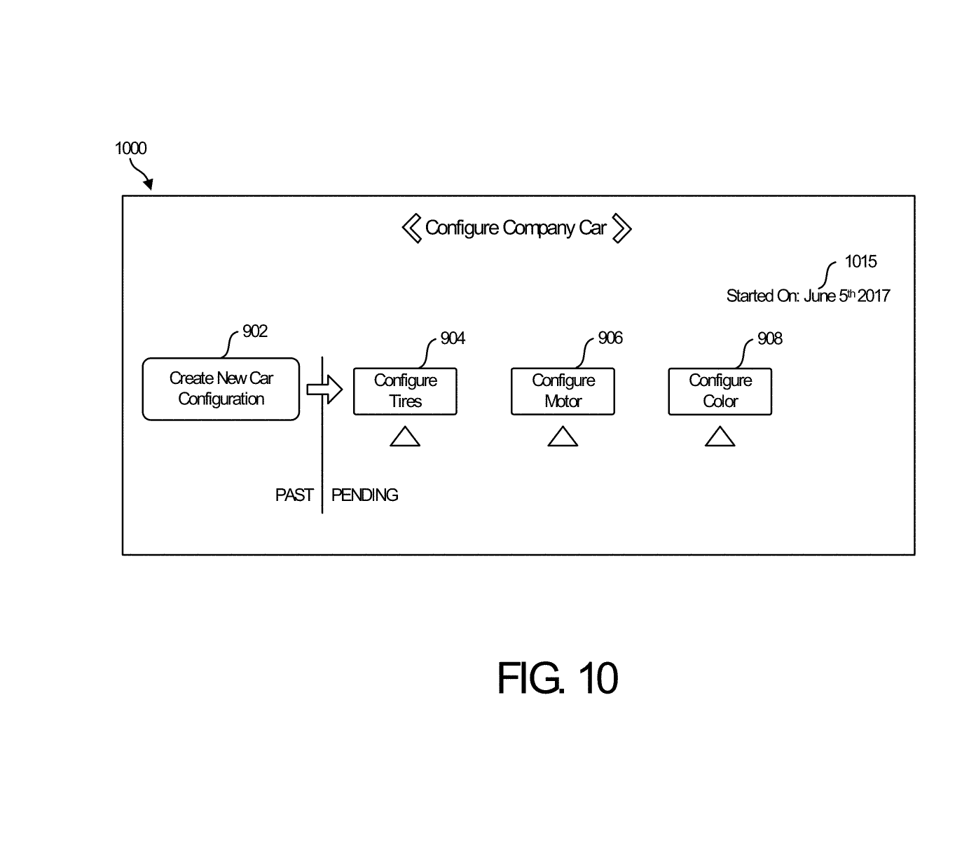

Once active, the parallel tasks 904, 906, and 908 would all show up under pending, but again without arrows between them. FIG. 10 depicts an exemplary user interface 1000, in accordance with some example implementations. As shown in FIG. 10, the tasks 904, 906, and 908 are shown as Pending with no arrows between them. Task 902 is shown as a past process completed on the left-hand side of the user interface 1000.

In some implementations, branches can be implemented in workflows. In some aspects, it is possible for the manager to reject the request for a company car. FIG. 11 depicts a workflow model 1100 with branches, in accordance with some example implementations. Workflow model 1100 comprises a start 1101, a user task 1102 (Request Permission to Order Company Car), a user task 1104 (Approve Company Car), an approve decision block 1105, an end process 1107, a user task 1108 (Configure Company Car), a user task 1110 (Order Company Car), a system task 1112 (Create Order), and an end of the process at 1115. As shown in FIG. 11, at decision block 1105, the workflow process can branch into two possible flows. If the manager does not approve of the request, the process ends at 1107. If the manager does approve, the process continues to user task 1108 (and subsequent user task 1110).

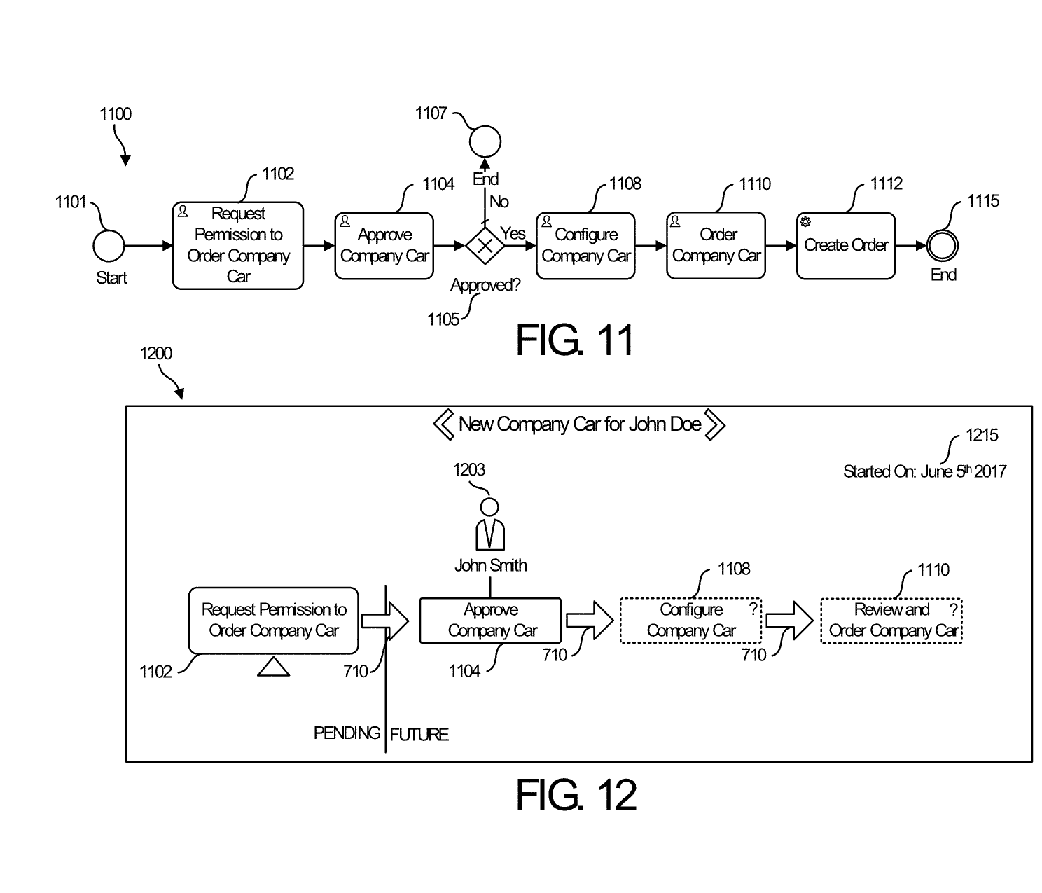

In such a case, depending on the approval outcome, configuring and ordering the company car would become optional. To account for this level of uncertainty, the My Processes view could visually highlight some future tasks as optional. FIG. 12 depicts an exemplary user interface 1200, in accordance with some example implementations. User interface 1200 comprises user tasks 1102, 1104, 1108, and 1110. User interface 1200 further comprises indicator 1203 to indicate that manager John Smith is responsible for user task 1104, arrows 710, and timestamp 1215. As shown in FIG. 12, the user tasks 1108 and 1110 are shown with dashed lines to indicate that the tasks are optional. In some aspects, other methods may be used to indicate the tasks as optional. For example, the tasks may be highlighted in a different color, have a different size, or shown in a different shape or location on the user interface.

As the My Processes view (e.g., user interface 1200) is a dynamic view, it can be tolerated that as the workflow instance progresses and the level of certainty increases, the visualization can change from optional to regular or vice versa.

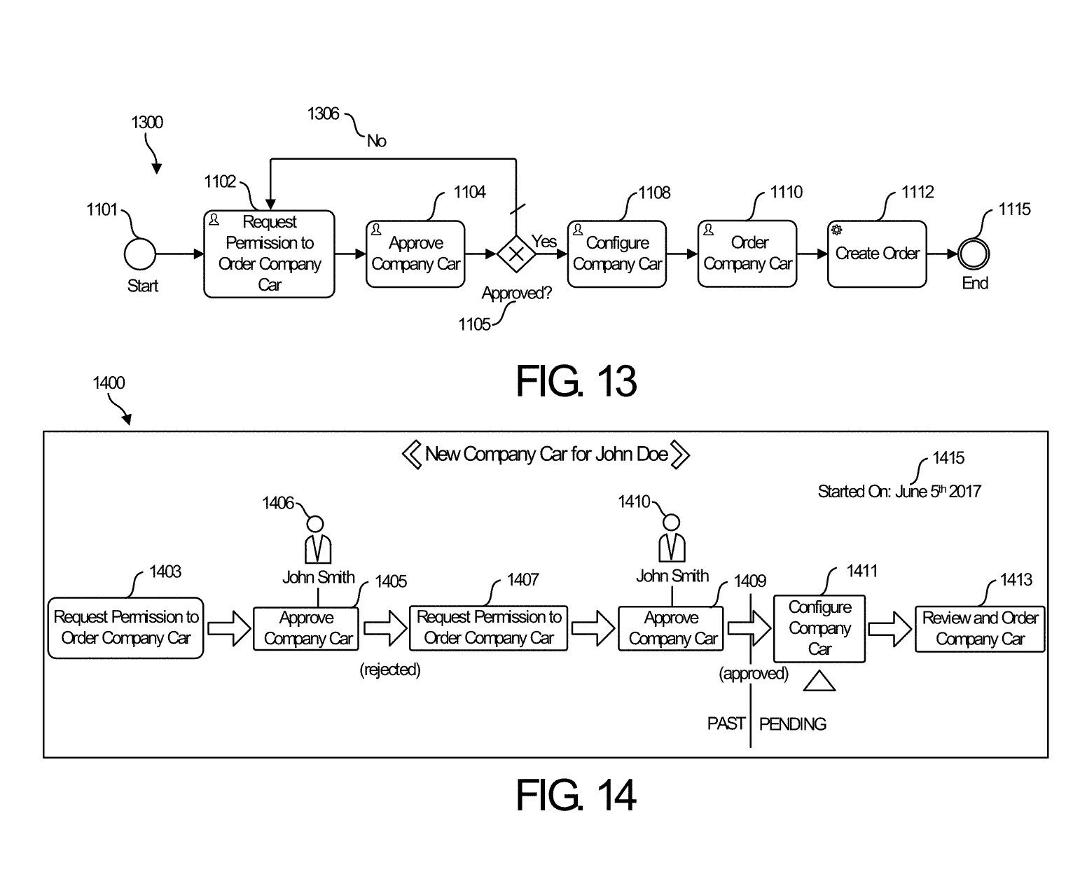

Workflows can also introduce loops into a process. Reconsidering the company car ordering process, a rejection could lead to the employee reworking his request. FIG. 13 depicts a workflow model 1300 with loops, in accordance with some example implementations. Workflow model 1300 is similar to and adapted from the workflow model 1100 of FIG. 11. Only differences between the workflow model 1300 and workflow model 1100 are discussed for the sake of brevity. As shown in FIG. 13, at decision block 1105, if the manager does not approve of the request, then the workflow process will follow loop 1306 and continue back at user task 1102.

In regards to the My Processes view, it may be desirable that future user tasks do not appear repeatedly (implying that upstream branches are ignored). In case of loops, only past user tasks can show up repeatedly. FIG. 14 depicts an exemplary user interface 1400, in accordance with some example implementations. As shown in FIG. 14, the left-hand side of the screen shows past user tasks and the right-hand side shows pending and/or future tasks. The user interface 1400 illustrates an example where the manager (John Smith) has rejected the request for ordering a company car at user task 1405. The employee (John Doe) at user task 1407 can revise his request (e.g., correct an error or provide more detail) and resubmit the request to his manager. At user task 1409, the manager has approved the revised request and the process proceeded to user task 1411 where the employee can configure the company car.

As could be seen from the company car ordering process (e.g., workflow models 500, 1100, and 1300), the employee was involved in three consecutive tasks. According to the protocol of displaying the next task to the user (see above), the client inbox can guide the user through step after step.

An issue that may arise is that after the first step, the manager needs to approve the company car ordering request. This is an asynchronous action in that the employee can't assume the manager to instantly approve. This could take a few days or even weeks if the manager was on vacation, for example. In such a case, no consecutive task can be presented to the user in the client inbox. Still, the user could see that he/she will eventually be involved into other tasks (as per the My Processes view), hence providing a value on its own.

Other examples of asynchronous actions include a catching Message Intermediate Event which waits for a message to be delivered to the workflow instance. Additionally, a Receive Task which waits for a message to be delivered to the workflow instance can lead to delays between consecutive tasks. Further, a catching Timer Intermediate Event waiting for a certain duration before advancing the workflow instance and an event-based gateway waiting for one of several events to occur before advancing the workflow instance could similarly result in no consecutive tasks being presented to the user in the client inbox but would be presented in the personalized custom view in a user interface which displays the past, pending, and/or future tasks assigned to the user (e.g., My Processes view).

The customized My Processes view can beneficially be applied to a wide variety of user interface environments. Additionally, the consecutive task arrangements described herein allow for other processes (e.g., backend system processes) to be run and implemented without affecting the customized user interfaces and the workflow model processes. Further, in contrast to user interface wizard configurations which are error-prone and tedious to implement, the consecutive task modeling and customized user interfaces provide improved accuracy and efficiency in data processing. Moreover, while user interface wizards require (re-) doing error handling, compensation handling, asynchronous communication, and auditing all within the user interface and outside of the control of the workflow, the consecutive task modeling described herein allows modifications to the workflow itself, improving flexibility in workflow modeling development. While many of the figures and examples described herein relate to a company car ordering process, the implementations described herein can apply to other workflow instances such as purchase orders, inventory, quality control, and/or the like.

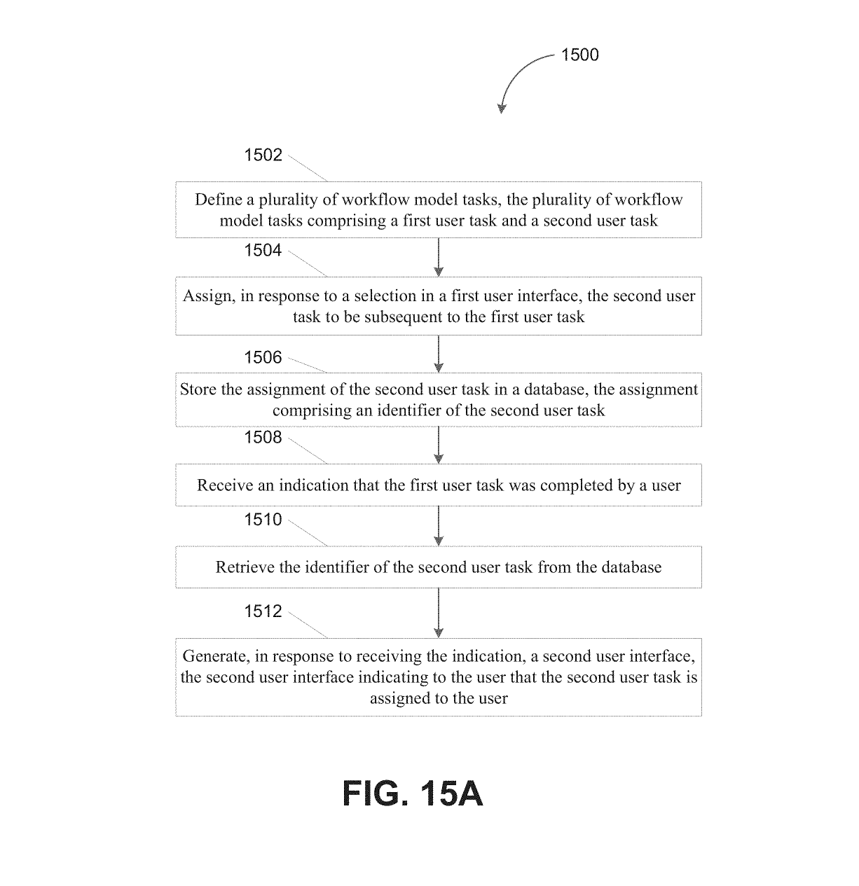

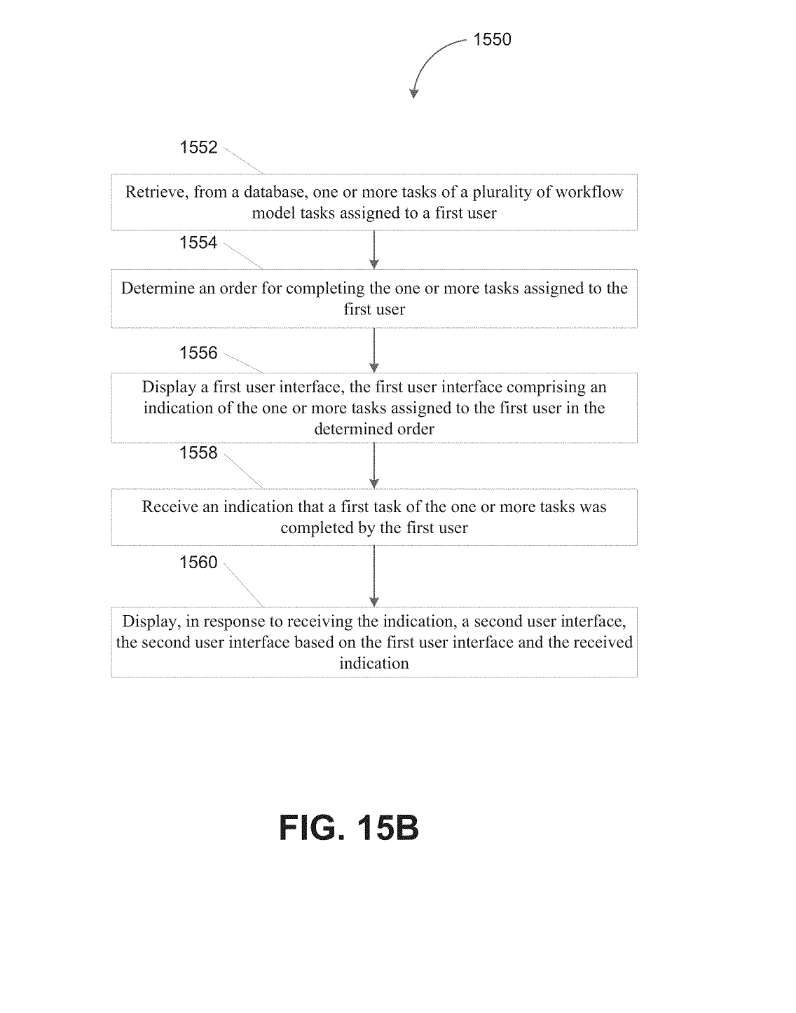

FIG. 15A depicts a flowchart illustrating a process 1500 for consecutive task modeling, in accordance with some example embodiments. In various implementations, the process 1500 (or at least a portion thereof) may be performed by one or more of the computing apparatus 1600, other related apparatuses, and/or some portion thereof. In some aspects, the apparatus 1600 may be regarded as a server and/or client device.

The process 1500 can start at operational block 1502 where the apparatus 1600, for example, can define, by at least one processor, a plurality of workflow model tasks, the plurality of workflow model tasks comprising a first user task and a second user task. In some implementations, the process 1500 can include storing, for each task of the plurality of workflow model tasks, a definition of a task in the database, the definition comprising a process for completing the task. Process 1500 can proceed to operational block 1504 where the apparatus 1600, for example, can assign, in response to a selection in a first user interface, the second user task to be subsequent to the first user task. Process 1500 can proceed to operational block 1506 where the apparatus 1600, for example, can store the assignment of the second user task in a database, the assignment comprising an identifier of the second user task.

Process 1500 can proceed to operational block 1508 where the apparatus 1600, for example, can receive an indication that the first user task was completed by a user. Process 1500 can proceed to operational block 1510 where the apparatus 1600, for example, can retrieve the identifier of the second user task from the database. In some aspects, retrieving the identifier includes querying, by the at least one processor, the database for an identifier of a subsequent task associated with the first user task and receiving, from the database and in response to the querying, a response indicating the identifier of the second user task. Additionally, the process 1500 can include displaying, to the user and in response to the querying, an indication that the at least one processor has not received the identifier of the subsequent task. In some aspects, the displaying can be based on a number of querying attempts and/or a time period threshold.

Process 1500 can proceed to operational block 1508 where the apparatus 1600, for example, can generate, in response to receiving the indication, a second user interface, the second user interface indicating to the user that the second user task is assigned to the user. In some aspects, the second user interface can indicate the completion of the first user task and can include a button directing the user to the second user task. In some aspects, the apparatus 1600 can further determine, in response to the assigning, whether the assignment of the second user task would result in an error in the plurality of workflow model tasks executed at runtime and display, in response to the determining, an error prompt to the user in a third user interface when the assignment is determined to result in an error.

FIG. 15B depicts a flowchart illustrating a process 1550 for consecutive task modeling, in accordance with some example embodiments. In various implementations, the process 1550 (or at least a portion thereof) may be performed by one or more of the computing apparatus 1600, other related apparatuses, and/or some portion thereof. In some aspects, the apparatus 1600 may be regarded as a server and/or client device.

The process 1550 can start at operational block 1552 where the apparatus 1600, for example, can retrieve, from a database, one or more tasks of a plurality of workflow model tasks assigned to a first user. In some implementations, the apparatus 1600 can query, by at least one processor, the database for a list of tasks assigned to the first user and receive, from the database and in response to the querying, a response indicating the one or more tasks assigned to the first user. Process 1550 can proceed to operational block 1554 where the apparatus 1600, for example, can determine an order for completing the one or more tasks assigned to the first user. Process 1550 can proceed to operational block 1556 where the apparatus 1600, for example, can display a first user interface, the first user interface comprising an indication of the one or more tasks assigned to the first user in the determined order. In some aspects, the first user interface comprises an indication of a task assigned to a second user. In some implementations, the task assigned to the second user must be completed prior to one of the one or more tasks assigned to the first user. In some aspects, two tasks of the one or more tasks assigned to the first user are configured to be completed in parallel. The first user interface can include an indication that the two task are configured to be completed in parallel. The first user interface can also include an indication that a task that is optional.

Process 1550 can proceed to operational block 1558 where the apparatus 1600, for example, can receive an indication that a first task of the one or more tasks was completed by the first user. Process 1550 can proceed to operational block 1560 where the apparatus 1600, for example, can display, in response to receiving the indication, a second user interface, the second user interface based on the first user interface and the received indication. In some aspects, the second user interface can an indication that the task assigned to the second user and/or a task assigned to the first user has been completed.

Performance of the processes 1500, 1550 and/or a portion thereof can allow for other processes (e.g., backend system processes) to be run and implemented without affecting the customized user interfaces and the workflow model processes. Further, the consecutive task modeling and customized user interfaces provide improved accuracy and efficiency in data processing by allowing users to perform consecutive task without waiting for system tasks and/or third party tasks to be completed.

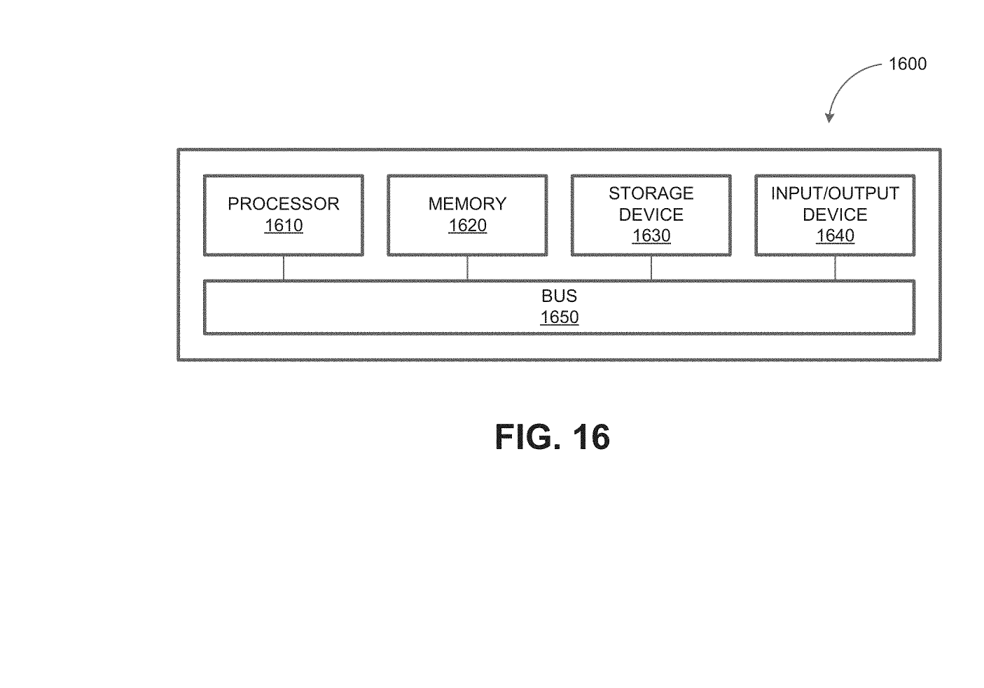

FIG. 16 depicts a block diagram illustrating a computing apparatus 1600 consistent with implementations of the current subject matter. Referring to FIGS. 1-14, the computing apparatus 1600 can be used to implement the workflow models 100, 300, 500, 800, 1100, 1300, and/or any components therein. For example, the computing apparatus 1600 can comprise the workflow engine and/or the client device described herein. Additionally, referring to FIGS. 3, 6, 7, 9, 10, 12, 14, the computing apparatus 1600 can be used to implement the user interfaces 350, 600, 700, 900, 1000, 1200, 1400 and/or any components therein. Referring to FIGS. 15A and 15B, the processes 1500 and 1550 may be performed by the computing apparatus 1600.

As shown in FIG. 16, the computing apparatus 1600 can include a processor 1610, a memory 1620, a storage device 1630, and input/output devices 1640. The processor 1610, the memory 1620, the storage device 1630, and the input/output devices 1640 can be interconnected via a system bus 1650. The processor 1610 is capable of processing instructions for execution within the computing apparatus 1600. Such executed instructions can implement one or more components of, for example, a client computing device or a server. In some example embodiments, the processor 1610 can be a single-threaded processor. Alternately, the processor 1610 can be a multi-threaded processor. The processor 1610 is capable of processing instructions stored in the memory 1620 and/or on the storage device 1630 to display graphical information for a user interface provided via the input/output device 1640.

The memory 1620 is a computer readable medium such as volatile or non-volatile that stores information within the computing apparatus 1600. The memory 1620 can store data structures representing configuration object databases, for example. The storage device 1630 is capable of providing persistent storage for the computing apparatus 1600. The storage device 1630 can be a floppy disk device, a hard disk device, an optical disk device, or a tape device, or other suitable persistent storage means. The memory 1620 and/or storage device 1630 can comprise a database within the computing apparatus 1600 or a databased stored on a server in communication with the computing apparatus 1600. In some aspects, the memory 1620 can comprise a cloud server in communication with the computing apparatus 1600 over a wired or wireless network. The input/output device 1640 provides input/output operations for the computing apparatus 1600. In some example embodiments, the input/output device 1640 includes a keyboard and/or pointing device. In various implementations, the input/output device 1640 includes a display unit for displaying graphical user interfaces.

According to some example embodiments, the input/output device 1640 can provide input/output operations for a network device. For example, the input/output device 1640 can include Ethernet ports or other networking ports to communicate with one or more wired and/or wireless networks (e.g., a local area network (LAN), a wide area network (WAN), the Internet).

In some example embodiments, the computing apparatus 1600 can be used to execute various interactive computer software applications that can be used for organization, analysis and/or storage of data in various formats. Alternatively, the computing apparatus 1600 can be used to execute any type of software applications. These applications can be used to perform various functionalities, e.g., planning functionalities (e.g., generating, managing, editing of workflow processes/tasks, databases, and/or any other objects, etc.), computing functionalities, communications functionalities, etc. The applications can include various add-in functionalities (e.g., SAP Integrated Business Planning as an add-in for a spreadsheet and/or other type of program) or can be standalone computing products and/or functionalities. Upon activation within the applications, the functionalities can be used to generate the user interface provided via the input/output device 1640. The user interface can be generated and presented to a user by the computing apparatus 1600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one processor; and
at least one memory storing instructions which, when executed by the at least one processor, result in operations comprising:
defining, by the at least one processor, a plurality of workflow model tasks, the plurality of workflow model tasks comprising a first user task and a second user task;
assigning, in response to a selection in a first user interface, the second user task to be subsequent to the first user task;
storing, by the at least one processor, the assignment of the second user task in a database, the assignment comprising an identifier of the second user task;
receiving, by the at least one processor, an indication that the first user task was completed by a user;
retrieving the identifier of the second user task from the database; and
generating, by the at least one processor and in response to receiving the indication, a second user interface, the second user interface indicating to the user that the second user task is assigned to the user.

2. The system of claim 1, wherein retrieving the identifier of the second user task comprises:
querying, by the at least one processor, the database for an identifier of a subsequent task associated with the first user task; and
receiving, from the database and in response to the querying, a response indicating the identifier of the second user task.

3. The system of claim 2, wherein the operations further comprise displaying, to the user and in response to the querying, an indication that the at least one processor has not received the identifier of the subsequent task.

4. The system of claim 3, wherein the displaying is based on a number of querying attempts and/or a time period threshold.

5. The system of claim 1, wherein the operations further comprise storing, for each task of the plurality of workflow model tasks, a definition of a task in the database, the definition comprising a process for completing the task.

6. The system of claim 1, wherein the second user interface indicates the completion of the first user task.

7. The system of claim 1, wherein the second user interface comprises a button directing the user to the second user task.

8. The system of claim 1, wherein the operations further comprise:
determining, in response to the assigning, whether the assignment of the second user task would result in an error in the plurality of workflow model tasks executed at runtime; and
displaying, in response to the determining, an error prompt to the user in a third user interface when the assignment is determined to result in an error.

9. A system, comprising:
at least one processor; and
at least one memory storing instructions which, when executed by the at least one processor, result in operations comprising:
retrieving, by the at least one processor from a database, one or more tasks of a plurality of workflow model tasks assigned to a first user;
determining, by the at least one processor, an order for completing the one or more tasks assigned to the first user;
displaying, by the at least one processor, a first user interface, the first user interface comprising an indication of the one or more tasks assigned to the first user in the determined order;
receiving, by the at least one processor, an indication of completion of a first task of the one or more tasks; and
displaying, by the at least one processor and in response to receiving the indication, a second user interface, the second user interface based on the first user interface and the received indication.

10. The system of claim 9, wherein retrieving the one or more tasks comprises:
querying, by the at least one processor, the database for a list of tasks assigned to the first user; and
receiving, from the database and in response to the querying, a response indicating the one or more tasks assigned to the first user.

11. The system of claim 9, wherein the first user interface comprises an indication of a task assigned to a second user.

12. The system of claim 11, wherein the task assigned to the second user must be completed prior to one of the one or more tasks assigned to the first user.

13. The system of claim 9, wherein two tasks of the one or more tasks assigned to the first user are configured to be completed in parallel.

14. A computer-implemented method, comprising:
defining, by at least one processor, a plurality of workflow model tasks, the plurality of workflow model tasks comprising a first user task and a second user task;
assigning, in response to a selection in a first user interface, the second user task to be subsequent to the first user task;
storing, by the at least one processor, the assignment of the second user task in a database, the assignment comprising an identifier of the second user task;
receiving, by the at least one processor, an indication that the first user task was completed by a user;
retrieving the identifier of the second user task from the database; and
generating, by the at least one processor and in response to receiving the indication, a second user interface, the second user interface indicating to the user that the second user task is assigned to the user.

15. The method of claim 14, wherein retrieving the identifier of the second user task comprises:
querying, by the at least one processor, the database for an identifier of a subsequent task associated with the first user task; and
receiving, from the database and in response to the querying, a response indicating the identifier of the second user task.

16. The method of claim 15, further comprising displaying, to the user and in response to the querying, an indication that the at least one processor has not received the identifier of the subsequent task.

17. The method of claim 16, wherein the displaying is based on a number of querying attempts and/or a time period threshold.

18. The method of claim 14, wherein the operations further comprise storing, for each task of the plurality of workflow model tasks, a definition of a task in the database, the definition comprising a process for completing the task.

19. A non-transitory computer-readable storage medium including program code, which when executed by at least one processor, causes operations comprising:
defining, by the at least one processor, a plurality of workflow model tasks, the plurality of workflow model tasks comprising a first user task and a second user task;
assigning, in response to a selection in a first user interface, the second user task to be subsequent to the first user task;
storing, by the at least one processor, the assignment of the second user task in a database, the assignment comprising an identifier of the second user task;
receiving, by the at least one processor, an indication that the first user task was completed by a user;
retrieving the identifier of the second user task from the database; and
generating, by the at least one processor and in response to receiving the indication, a second user interface, the second user interface indicating to the user that the second user task is assigned to the user.

20. The medium of claim 19, wherein retrieving the identifier of the second user task comprises:
querying, by the at least one processor, the database for an identifier of a subsequent task associated with the first user task; and
receiving, from the database and in response to the querying, a response indicating the identifier of the second user task.
